(19) United States
(12) Patent Application Publication
(10) Pub. No.: US 2004/0054562 A1
(43) Pub. Date: Mar. 18, 2004

(54) Multi-perspective enterprise management tool

(76) Inventor: Motoo Tanaka, Pleasanton, CA (US)

Correspondence Address: HEWLETT-PACKARD COMPANY, Intellectual Property Administration, P.O. Box 272400, Fort Collins, CO, 80527-2400, US

(21) Appl. No.: 10/245,668

(22) Filed: Sep. 16, 2002

(51) Int. Cl. G06F 17/60

(52) U.S. Cl. 705/7

(57) ABSTRACT

A system and method is disclosed for enterprise information management. The method of the present invention discloses: completing a set of fields within a uniformly formatted employee work record; partitioning the employee work record by project into a set of project specific work records; selecting a subset of the project specific employee work records using a predetermined set of filtering criteria; and generating an enterprise report from the selected subset of work records. The method also discloses: completing a set of fields within a uniformly formatted project work record having a uniform format; partitioning the project work record by employee into a set of employee specific work records; selecting a subset of the employee specific employee work records using a predetermined set of filtering criteria; and generating an enterprise report from the selected subset of work records. The system discloses some means for effecting the method.

### BACKGROUND OF THE INVENTION

1. Field of the Invention

The present invention relates generally to systems and methods for enterprise management, and more particularly to systems and methods for employee and project management within an enterprise.

2. Discussion of Background Art

Managers are customarily responsible for not only gathering information about many different projects and reviewing those projects against their original project plans, but also gathering and reviewing information on each project team's members. To that end, managers must investigate sources of, solicit, compile, and then interpret such employee and project information.

During the investigation stage, a manager must manually identify all outstanding projects as well as those individuals making up each project team. Such investigation often requires that the manager expend a significant amount of effort performing database searches and/or talking to a significant number of employees and project managers, just to get an idea of what everyone is working on.

During the solicitation stage, the manager typically must request a different set of information from each of the team members for each of the projects. These requests are often sent out at differing times and requesting that the information solicited be provided in a variety of different formats. Not only is such a manual procedure laborious for the manager, it is also very time consuming from the point of view of those solicited. For instance, not only must each solicited team member organize the requested information into a variety of different formats, but other such report request contain overlapping fields which the team member must enter again and again into each of the requested reports.

During the compilation stage, the requested information often comes back piecemeal, from differing team members, on differing projects, and over differing work periods. The manager must then spend considerable time collating the information for each project, each employee, and over various time periods. Once collated, the manager must then manually enter the information into one or more reports requested by that manager's upper management or as individually preferred by that manager for their own use.

Only during the interpretation stage, can the manager finally begin to understand how each project is progressing and how each team member is contributing. While this last stage is the most important, unfortunately most of a manager's time is spent on the three previous stages. And, by the time this fourth stage is reached collected information may now be outdated.

Due to these latency and other problems, discussed above, individual project team member's current and future accomplishments, are poorly linked to a project's overall current and future status. There simply is not an easy and real time way to collect and review both the individual status of a team member concurrent with the global status of a number of projects.

In response to the concerns discussed above, what is needed is a system and method for employee and project management that overcomes the problems of the prior art.

### SUMMARY OF THE INVENTION

The present invention is a system and method for enterprise management. Within the method of the present invention includes: completing a set of fields within a uniformly formatted employee work record; partitioning the employee work record by project into a set of project specific work records; selecting a subset of the project specific employee work records using a predetermined set of filtering criteria; and generating an enterprise report from the selected subset of work records.

An alternate embodiment of the present invention may include: completing a set of fields within a uniformly formatted project work record having a uniform format; partitioning the project work record by employee into a set of employee specific work records; selecting a subset of the employee specific employee work records using a predetermined set of filtering criteria; and generating an enterprise report from the selected subset of work records.

Other alternate embodiments may include the steps of: selecting a data region within the enterprise report; displaying a subset of work records from the project specific work records which were used to generate the selected data region, in response to the selection, as well as other elements.

The system of the present invention includes all means for effecting the method. These and other aspects of the invention will be recognized by those skilled in the art upon review of the detailed description, drawings, and claims set forth below.

### BRIEF DESCRIPTION OF THE DRAWINGS

FIG. 1 is one embodiment of a method for multi-perspective enterprise management;

FIG. 2 is one embodiment of an overall work record data structure for entering employee work records into an enterprise management tool;

FIG. 3 is one embodiment of a set of project specific work record data structures, partitioned from the overall work record data structure, for organizing work records within the tool;

FIG. 4 is one embodiment of a timeline showing an exemplary set of project specific work records, organized according to their respective date ranges;

FIG. 5 is one embodiment of a project report, generated from the exemplary set of project specific work records;

FIG. 6 is one embodiment of an employee report, generated from the exemplary set of project specific work records; and

FIG. 7 is one embodiment of a budget report, generated from the exemplary set of project specific work records.

### DETAILED DESCRIPTION OF THE PREFERRED EMBODIMENT

The present invention provides a system and method for enterprise management, including collecting overall project and individual project team member information using a uniform format for entering work records, which are then compiled into a searchable and filterable time domain database. Results from queries performed on such a work record database can then be displayed to managers using any number of report formats, thus providing managers with multiple perspective views of each project, and each individual team member's contributions thereto. Using the present invention, a manager can monitor and control activities and costs associated with each team member and project in a much more data and time efficient manner.

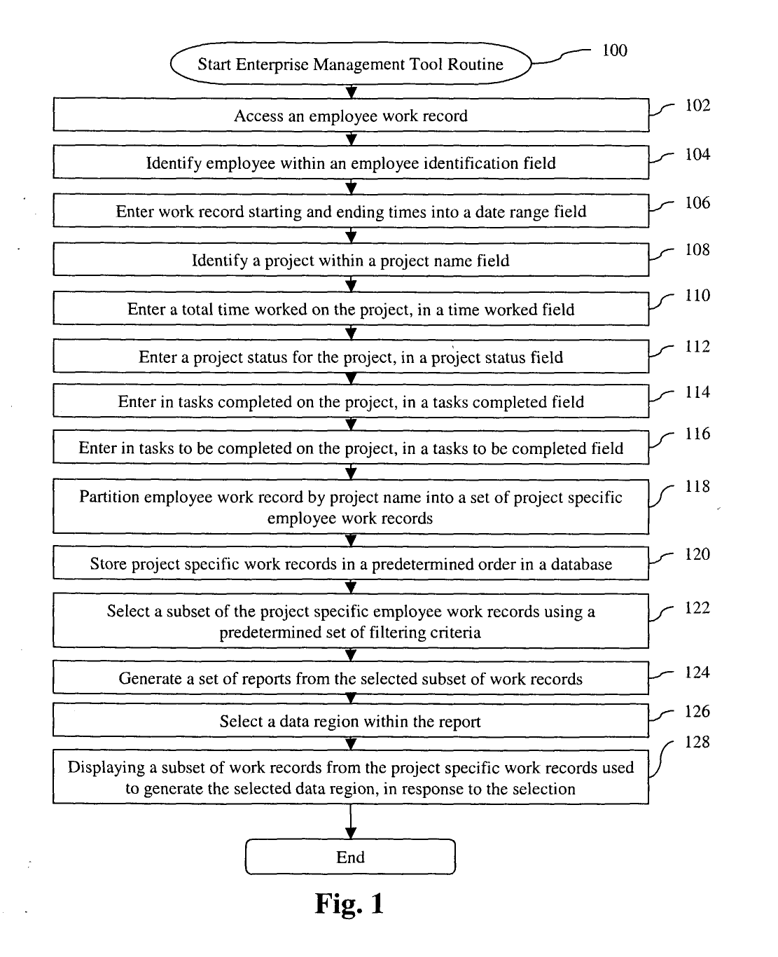

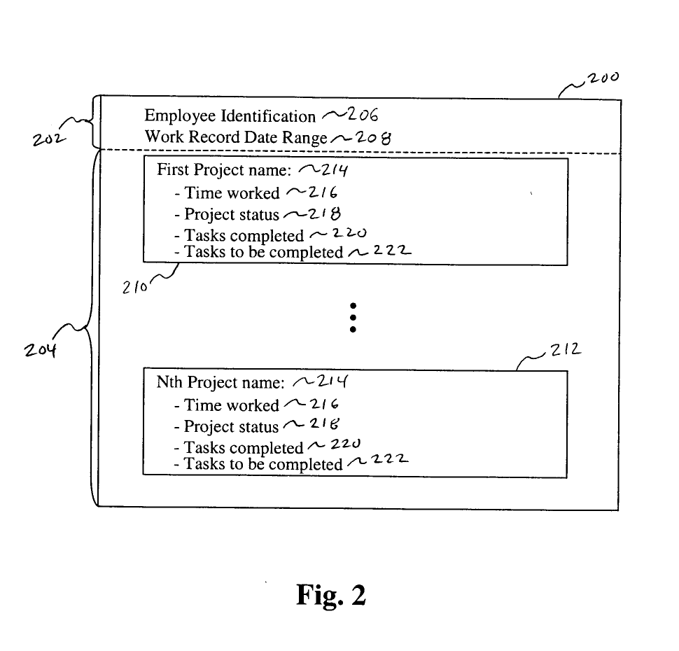

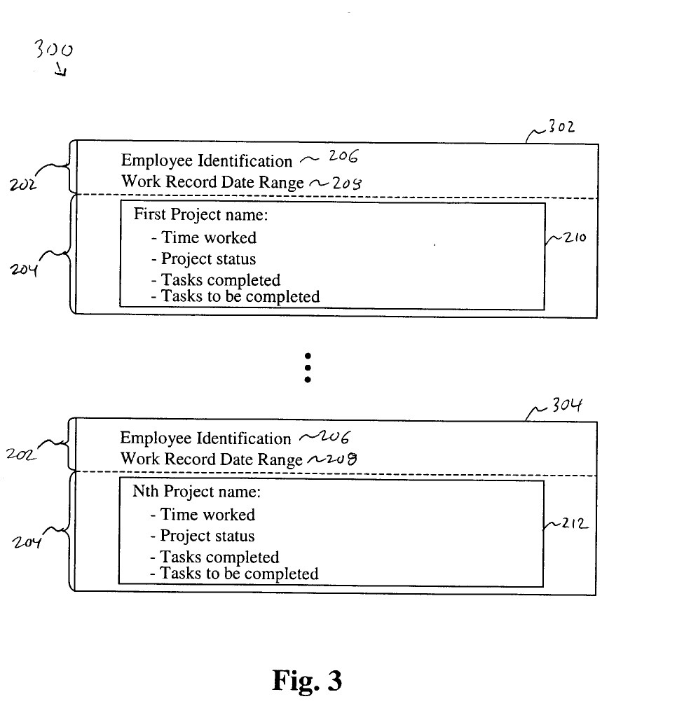

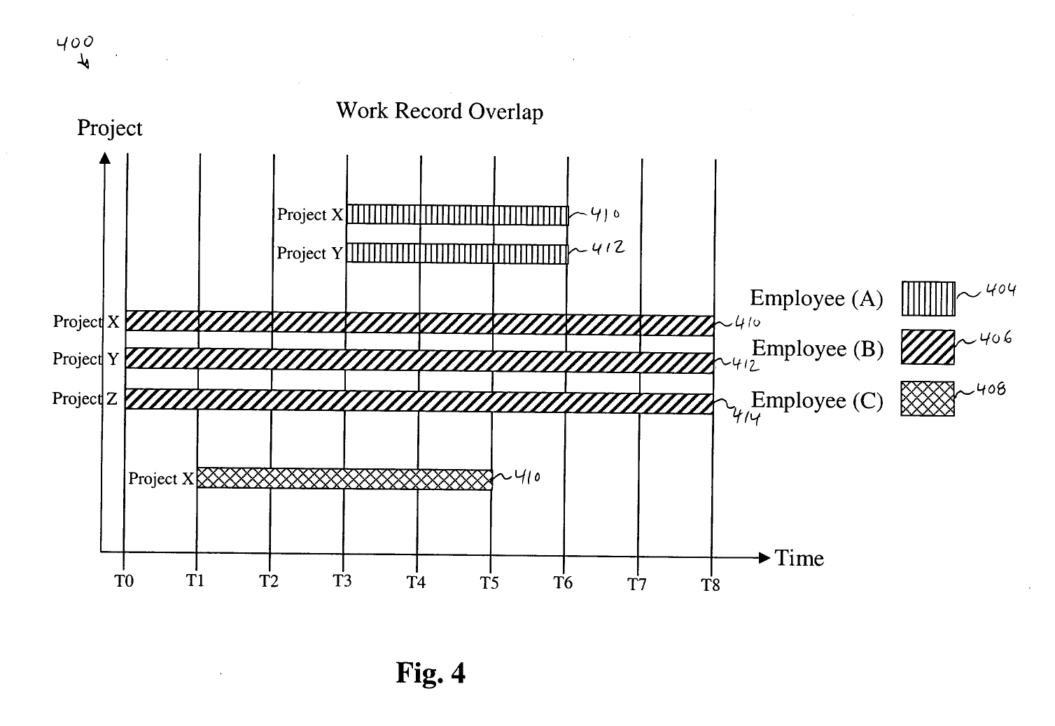

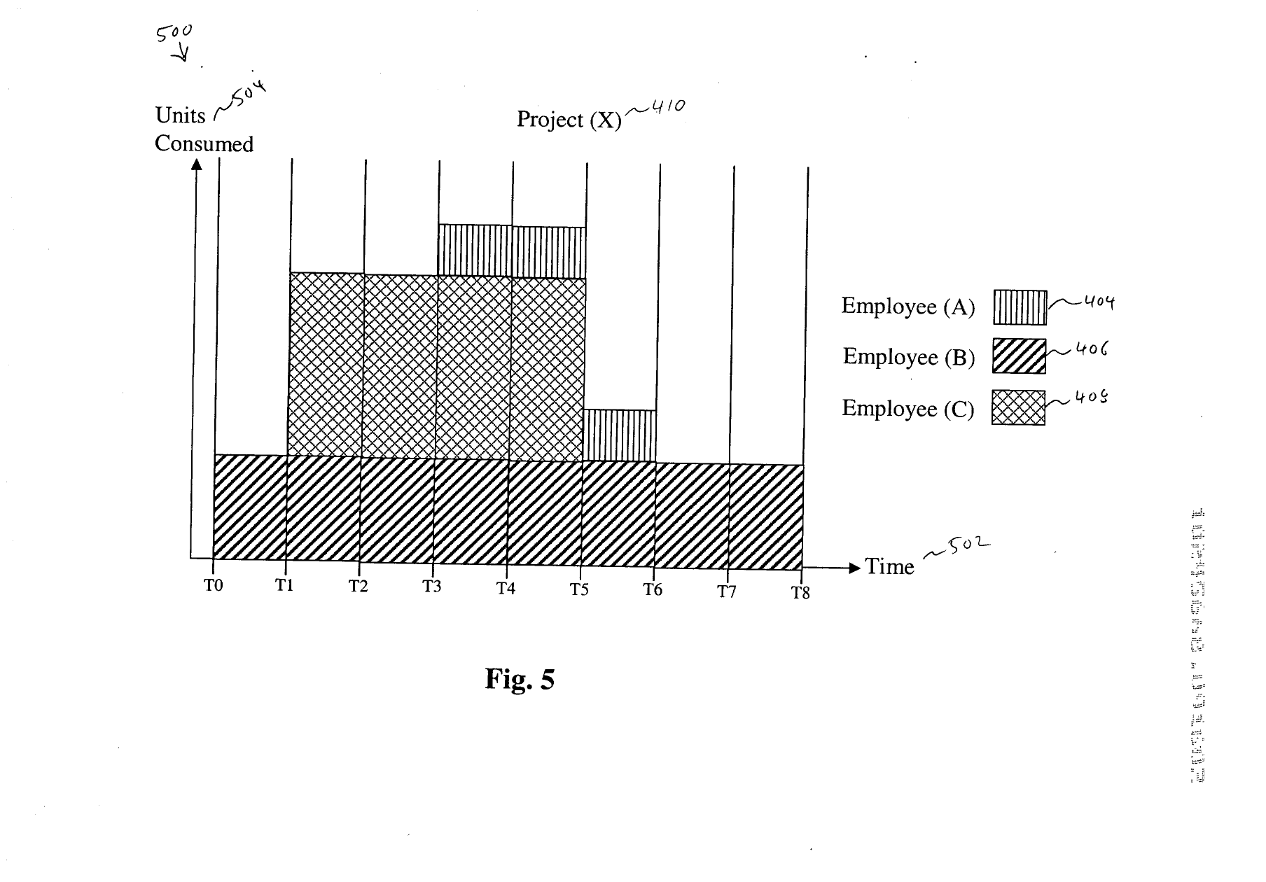

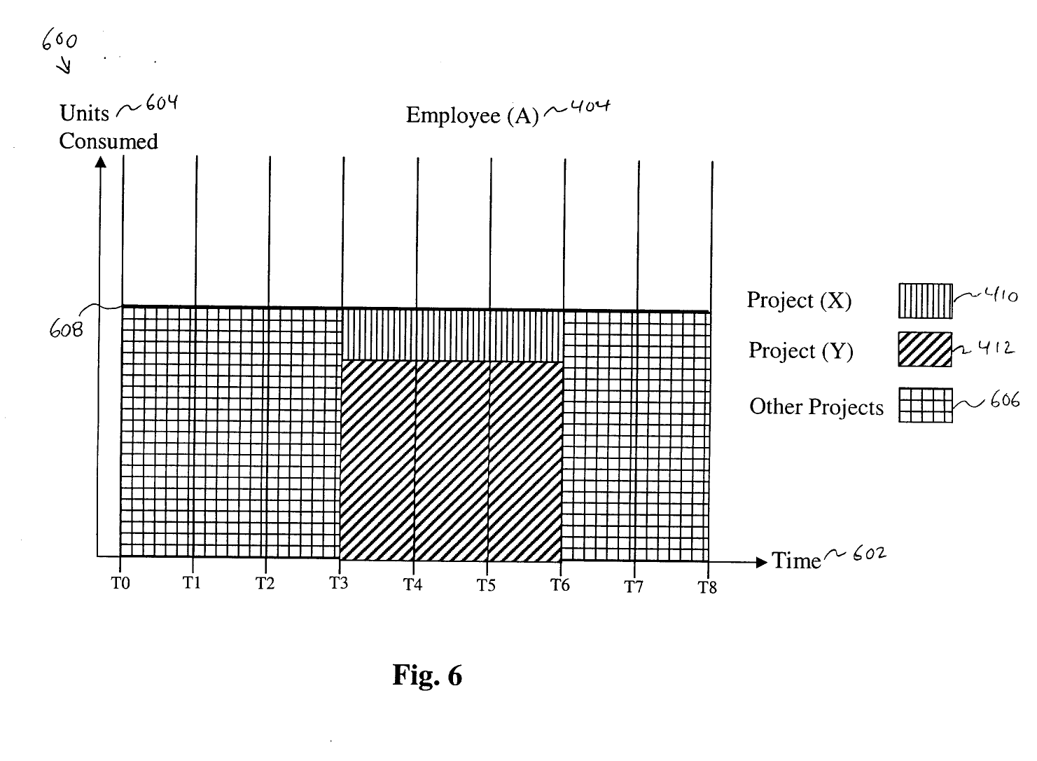

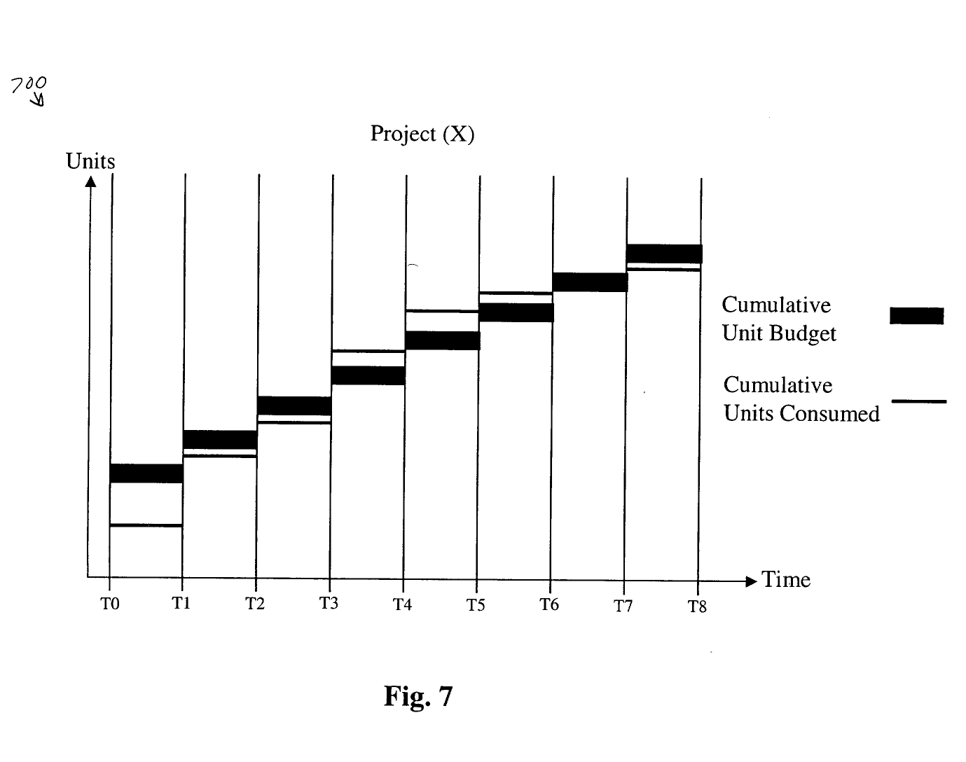

FIG. 1 is one embodiment of a method 100 for multi-perspective enterprise management. FIG. 2 is one embodiment of an overall work record data structure 200 for entering employee and/or project work records into a multi-perspective enterprise management tool. FIG. 3 is one embodiment of a set of project specific work record data structures 300, partitioned from the overall work record data structure, for organizing work records within the enterprise management tool. FIG. 4 is one embodiment of a timeline 400 showing an exemplary set of project specific work records, organized according to their respective date ranges. FIG. 5 is one embodiment of a project report 500, generated from the exemplary set of project specific work records. FIG. 6 is one embodiment of an employee report 600, generated from the exemplary set of project specific work records. FIG. 7 is one embodiment of a budget report 700, generated from the exemplary set of project specific work records. FIGS. 1 through 7 are now discussed together. Note that while the present invention's example work record data structure is optimized with respect to a set of employee's entering information on a set of projects which they are currently working on, the present invention's work record data structure could easily be re-optimized for a program manager entering in information on a set of projects supporting such program, and so on.

The method 100 begins in step 102 where an employee accesses a new uniformly formatted instance of the work record data structure 200. Uniformly formatted means that the work record format adheres to a consistent format regardless of the employee or project related information entered into the work record. Note, however, that uniformly formatted does not mean that each work record contains an identical set of fields for entering information, rather uniformity is instead tied to a consistent way of entering information into each field which happens to appear in one or more of the work records. The work record data structure 200 may be hosted either by software on the employee's own computer, or remotely from a network server computer. The work record 200 includes two main sections, a header 202 and a body 204. In step 104, the employee identifies themselves within an employee identification field 206. In the examples to follow, shown in FIGS. 4 through 6, the employee identification field 206 is populated with an employee (A) 404, an employee (B) 406, and an employee (C) 408. Those skilled in the art recognize that in alternate embodiments of the present invention, the employee identification field 206 can be replaced with any type of identification field.

Next in step 106, the employee enters a starting time and an ending time within a work record date range field 208. Since, the work records 200 are preferably designed to permit a maximum flexibility for both an employee entering in information, and a manager retrieving the same, the starting and ending time are left to the discretion of the employee. Thus for some employees the date range 208 will be only part of one day, but for others it may be for an entire week. In the FIGS. 4 through 6 examples to follow, the date range field 208 for employee (A) 404 has a starting time (T3) and an ending time of (T6), where T represents an arbitrary time increment. For employee (B) 406, the date range field 208 for has a starting time (T0) and an ending time of (T8), and for employee (C) 408, the date range field 208 for has a starting time (T1) and an ending time of (T5).

In step 108, the employee enters in a project name within a project name field 214 for each project which the employee has worked on during the specified date range 208. The project name begins with a first project name 210 and may extend to an Nth project name 212. In the FIGS. 4 through 6 examples to follow, employee (A) 404 has populated the project name field 208 with a project (X) 410 and a project (Y) 412. Similarly, employee (B) 406 has populated the project name field 208 with project (X) 410, project (Y) 412, and a project (Z) 414. However, employee (C) 408 has populated the project name field 208 with only project (X) 410.

Next in step 110, the employee enters in a total time worked, in a time worked field 216, for each of the projects within the specified date range. For instance, the employee may have worked 2 hours on the first project 210, and 38 hours on the Nth project 212. In step 112, the employee enters in a project status, in a project status field 218, for each of the projects within the specified date range. For instance, the employee the first project 210 may have a status of “on schedule,” while the Nth project 212 may have a status of “ahead of schedule.” In step 114, the employee enters in tasks completed, in a tasks completed field 220, for each of the projects within the specified date range. For instance, tasks completed on the first project 210 may include “preliminary design completed” and “software coding to begin,” while the Nth project 212 has its own set of tasks completed. In step 116, the employee enters in tasks to be completed, in a tasks to be completed field 220, for each of the projects within the specified date range. For instance, tasks to be completed on the first project 210 may include “final design signoff” and “initial software testing” and of course the Nth project 212 has its own set of tasks yet to be completed.

In step 118, each employee's work record data structure 200 is partitioned by project name. Thus, as shown in FIG. 3, new project specific work record data structures 302 through 304 are created for the first project 210 through the Nth project 212. Each of the project specific work records 302, 304 retain the same header field 202 for that employee. However, the body 204 of each of the project specific work records 302, 304 is now associated with only one project name.

The effects steps 106 through 118 are graphically shown using the timeline 400 in FIG. 4. In the figure, employee (A)'s 404 work record for project (X) 410 has been partitioned from the employee (A)'s 404 work record for project (Y) 412. Note that the partitioned records retain the same date range from (T3) to (T6) as originally entered by employee (A) 404 into the date range field 208. Similarly, employee (B)'s 406 and employee (C)'s 408 work record partitioning are shown. Next, in step 120, store each of the project specific employee work records in a predetermined order in a database, such as a time domain database. The records are preferably stored in order of their start time within the date range field 208. However, the records could alternatively be stored in any other order, such as in order of their project name within the project name field 214. In the example shown in FIG. 4, employee (B)'s 406 project specific work records are stored in the time domain database first, since their start time is (T0), employee (C)'s 408 project specific work record is stored in the time domain database second, since its start time is (T1), and employee (A)'s 404 project specific work records are store in the time domain database third, since their start time is (T3).

In step 122 a subset of the project specific employee work records are selected using a predetermined set of filtering criteria supplied by the manager, or any other interested party. The filtering criteria can select work records based on any of the data contained in any of the fields 206 through 222, within the project specific work record.

In step 124, a predetermined set of reports are generated from the selected subset of work records in a particular format, in response to the manger's, or another's, request. Reports may include reports: showing a cumulative time worked by an employee on a predetermined set of projects; showing a cumulative time worked by a set of employees on a predetermined project; comparing a cumulative costs incurred on a project to a cumulative cost budget; and comparing a cumulative cost incurred by an employee on a set of project to a cumulative employee cost budget. In cases where the project specific work records cover a date range longer than a date range increment specified within the particular report format requested, data within the time worked field 216 is averaged/pro-rated based on the requested date range increment.

Examples of some reports that may be generated are shown in FIGS. 5 through 7. In FIG. 5, the project specific work records stored in the time domain database have been selected using “project (X)” and date range increment (T0>T8) filters in order to generate the project report 500. Thus the project report's 500 time axis 502 begins at TO, increments by 1, and then ends at T8. A title at the top of the report 500 indicated that the information displayed is for project (X) 410. A units consumed axis 504 most likely will correspond to either a cumulative “time worked” by all employees, but may also correspond to other units which have meaning to the manager. In the report 500, since employee (B) 406 work record covered the full T0 through T8 date range, employee (B)'s total time worked in the time worked field 216 is averaged over the entire date range. Thus if employee (B) entered a time worked of 80 hours, then the 80 hours are divided by the eight time increments shown on the time axis 502 and employee (B)'s “time units consumed” is set to 10 hours for each increment. Similar averaging is done for employee (A)'s 404 and employee (C)'s 408 time worked.

In FIG. 6, the project specific work records stored in the time domain database have been selected using “employee (A)” and date range increment (T0>T8) filters in order to generate the employee report 600. Thus the employee report's 600 time axis 602 begins at T0, increments by 1, and then ends at T8. A title at the top of the report 600 indicated that the information displayed is for employee (A) 404. A units consumed axis 504 will typically correspond to the employee's cumulative time worked on various projects during the date range, which for employee (A) 404, includes project (X) 410, project (Y) 412, and a set of other projects 606. An expected units consumed indicator 608 helps indicate whether an employee is over-working or under-working. Note, multiple employee reports 600 for different employees may be displayed simultaneously so that the manager can perform “load balancing” throughout the team. In the example shown, employee (A) 404 is neither over-working or under-working since the units consumed during each time period is equal to the expected units consumed indicator 608.

In FIG. 7, a budget report 700 has been generated using the project specific work records stored in the time domain database which have been filtered using “project (X)” and date range increment (T0>T8) filters. Additional information on project revenue/budget and employee pay rates has also been factored in using known financial analysis equations. Thus, the budget report 700 shows at a glance whether or not a project in within or beyond the revenue received and/or budget allowed.

The budget report 700 can easily be modified to track an individual employee's costs, as well as for any number of employee work teams. Those skilled in the art will recognize that many different types of reports can also be generated using the employee work record data structure 200.

In step 126, the manager selects a particular data region within one of the reports. For example, the manager may use a mouse control to click on employee (A)'s 404 activity on project (X) 410 between times T3 and T4 in FIG. 5, as shown by the shaded parallel vertical lines. In step 128, a subset of work records from the project specific work records used to generate the selected data region are displayed to the user, in response to the selection step. Thus each region on a report is hyperlinked to a relevant employee work record. In the example shown, the employee's project specific work record 302 corresponding to project (X) 410 is, or all of the employee's work records 200 are, presented to the manager.

In this way, the manager can view that employee's detailed information regarding that work record, and including information within: the time worked field 216, the project status field 218, the tasks completed field 220, and the tasks to be completed field 220. Those skilled in the art recognize that the present invention's data structure 100 can be scaled to any number of employees, projects, and/or other information deemed important to a user of the present invention.

While one or more embodiments of the present invention have been described, those skilled in the art will recognize that various modifications may be made. Variations upon and modifications to these embodiments are provided by the present invention, which is limited only by the following claims.

What is claimed is:

1. A method for enterprise management, comprising:
completing a set of fields within a uniformly formatted employee work record;
partitioning the employee work record by project into a set of project specific work records;
selecting a subset of the project specific employee work records using a predetermined set of filtering criteria; and
generating an enterprise report from the selected subset of work records.

2. The method of claim 1 further comprising:
selecting a data region within the enterprise report; and
displaying a subset of work records from the project specific work records which were used to generate the selected data region, in response to the selection.

3. The method of claim 1:
wherein the completing element includes, defining a work record date range, including a starting time and an ending time, to which the work record pertains; and
the method of claim 1 further comprising, storing the project specific work records in order of their start time.

4. The method of claim 1:
wherein the completing element includes, attributing a set of employee information with the employee work record; and
wherein the partitioning element includes partitioning the employee work record so that each project specific work record contains a copy of the employee information, but only information on one project.

5. The method of claim 1, wherein the completing element includes:
defining a set of projects which the employee worked on;
specifying a total time worked on each of the projects;
specifying a project status for each of the projects;
listing a set of tasks completed for each of the projects; and
listing a set of tasks to be completed for each of the projects.

6. The method of claim 1, wherein the selecting element includes:
selecting only those work records having a predetermined set of data within the project specific work record fields.

7. The method of claim 1, wherein the selecting element includes:
selecting only those work records pertaining to a specific date range and a specific employee.

8. The method of claim 1, wherein the selecting element includes:
selecting only those work records pertaining to a specific date range and a specific project.

9. The method of claim 1, wherein the generating element includes:
displaying an average time worked for each increment within a requested date range for project specific work records having a date range longer than the increment within the requested date range.

10. The method of claim 1, wherein the generating element includes:
generating a report showing a cumulative time worked by an employee on a predetermined set of projects.

11. The method of claim 1, wherein the generating element includes:
generating a report comparing a cumulative time worked by an employee on a predetermined set of projects to a expected units consumed indicator.

12. The method of claim 1, wherein the generating element includes:
generating a report showing a cumulative time worked by a set of employees on a predetermined project.

13. The method of claim 1, wherein the generating element includes:
generating a report comparing a cumulative costs incurred on a project to a cumulative cost budget.

14. The method of claim 1, wherein the generating element includes:
generating a report comparing a cumulative cost incurred by an employee on a set of project to a cumulative employee cost budget.

15. A method for enterprise management, comprising:
completing a set of fields within a uniformly formatted project work record having a uniform format;
partitioning the project work record by employee into a set of employee specific work records;
selecting a subset of the employee specific employee work records using a predetermined set of filtering criteria; and
generating an enterprise report from the selected subset of work records.

16. The method of claim 15 further comprising:
selecting a data region within the enterprise report; and
displaying a subset of work records from the employee specific work records which were used to generate the selected data region, in response to the selection.

17. The method of claim 15:
wherein the completing element includes, attributing a set of project information with the project work record; and
wherein the partitioning element includes partitioning the project work record so that each employee specific work record contains a copy of the project information, but only information on one employee.

18. A method for enterprise management, comprising:
completing a set of fields within a uniformly formatted employee work record;
partitioning the employee work record by project into a set of project specific work records;
selecting a subset of the project specific employee work records using a predetermined set of filtering criteria; and
generating an enterprise report from the selected subset of work records;
selecting a data region within the enterprise report; and
displaying a subset of work records from the project specific work records which were used to generate the selected data region, in response to the selection; and
wherein the completing element includes, defining a set of projects which the employee worked on;
specifying a total time worked on each of the projects;
specifying a project status for each of the projects;
listing a set of tasks completed for each of the projects; and
listing a set of tasks to be completed for each of the projects

19. A system for enterprise management, comprising:
means for completing a set of fields within a uniformly formatted employee work record;
means for partitioning the employee work record by project into a set of project specific work records;
means for selecting a subset of the project specific employee work records using a predetermined set of filtering criteria; and
means for generating an enterprise report from the selected subset of work records.

20. The method of claim 19 further comprising:
means for selecting a data region within the enterprise report; and
means for displaying a subset of work records from the project specific work records which were used to generate the selected data region, in response to the selection.
